(19) United States
(12) Patent Application Publication
(10) Pub. No.: US 2010/0267541 A1
(43) Pub. Date: Oct. 21, 2010

(54) Nano-ceramics and method thereof

(75) Inventors: Joe H. Satcher, JR., Patterson, CA (US); Alexander E. Gash, Livermore, CA (US); Randall L. Simpson, Livermore, CA (US); Richard L. Landingham, Livermore, CA (US); Robert A. Reibold, Salida, CA (US)

Correspondence Address: Deputy Laboratory Counsel For Intellectual;Property, Lawrence Livermore National Laboratory, P.O. Box 808, L-703, Livermore, CA, 94551-0808, US

(73) Assignee: The Regents of the University of CA

(21) Appl. No.: 11/477,331

(22) Filed: Jun. 28, 2006

Related U.S. Application Data
(63) Continuation-in-part of application No. 10/447,119, filed on May 28, 2003, now Pat. No. 7,087,544.
(60) Provisional application No. 60/384,365, filed on May 29, 2002.

(51) Int. Cl. C04B 35/563; C04B 35/624

(52) U.S. Cl. 501/87; 501/153

(57) ABSTRACT

A method for producing ceramic materials utilizing the sol-gel process enables the preparation of intimate homogeneous dispersions of materials while offering the ability to control the size of one component within another. The method also enables the preparation of materials that densify at reduced temperatures. Applications of the compositions include filters, solid-oxide fuel cells, membranes, ceramic cutting tools and wear and auto parts. In one example, 10 g of AlCl₆.6H₂O is added to a 150 ml beaker and dissolved in 10 g EtOH and 1 g H₂O. While stirring, 0.456 g of B₄C powder is added. Then 9.6 g of propylene oxide is added. The gel sets up in about 10 minutes and is dried overnight. It is then washed with 1% NH₄OH and air dried to yield 3.969 g of Al₂O₃/B₄C xerogel.

This is a continuation-in-part of U.S. patent application Ser. No. 10/447,119, titled: “Nano-Ceramics and Method Thereof” filed May 28, 2003, incorporated herein by reference, which claims priority to U.S. Provisional Patent Application No. 60/384,365, titled: “Preparation of Nano-ceramics Using Sol-Gel Methods” filed May 29, 2002, incorporated herein by reference.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

Oxides and hydroxides of inorganic oxide materials, most notably aluminum, are among the most industrially useful chemicals. Their uses include precursors for the preparation of structural ceramics, electronic components, catalysts and their supports, adsorbents, and reinforcing agents. Traditional ceramic processing typically involves powder processing, shape-forming, and densification.

### SUMMARY OF THE INVENTION

It is an object of the present invention to provide a method for the preparation of materials having ultrafine cell/pore sizes, continuous porosity, high surface area, and a microstructure composed of interconnected colloidal-like particles or polymeric chains with characteristic diameters in the 100 Å range.

Another object of the invention to treat a gel formed by the method of the present invention such that they will have a solution pH that will achieve the isoelectric point for the particular material of the gel to obtain a desirable free-flowing powder morphology.

An embodiment of the method includes dissolving at least one metal salt in a solvent or solvent matrix to form a metal salt solution; adding a proton scavenger to the metal salt solution to form a gel; washing the gel with a solvent having a ph that will produce about no net charge in at least a portion of the gel; and drying the gel to form a composite material.

Another embodiment of the present invention is a method that includes dissolving at least one metal salt in a solvent or solvent matrix to form a metal salt solution; adding at least one uniformly dispersed powdered material to the metal salt solution to form a composite dispersion; adding a proton scavenger to the composite dispersion to form a gel; washing the gel with a solvent having a ph that will produce about no net charge in at least a portion of the gel; and drying the gel to form a composite material.

Still another embodiment is method comprising dissolving at least one metal salt in a solvent or solvent matrix to form a metal salt solution; adding at least one uniformly dispersed powdered material to the metal salt solution to form a composite dispersion, wherein the powdered material is selected from the group consisting of a carbide, a nitride, a boride and a metal; adding a proton scavenger to the composite dispersion to form a gel; and drying the gel to form a composite material. This method also includes washing the gel with a solvent having a ph that will produce about no net charge in at least a portion of said gel.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 (Table 2) lists the dimensions before and after sintering of pellets from Samples A-I.

FIGS. 2A-2D show X-ray diffraction patterns of pellets produced from Sample A and Sample C.

FIG. 3 is an SEM micrograph of Sample B at 6,000 times magnification.

FIG. 4A is an SEM micrograph of Sample C at 6,000 times magnification.

FIG. 4B is an SEM micrograph of Sample C at 3,000 times magnification.

FIG. 5A is an SEM micrograph of a 30 vol. % B₄C/Al₂O₃ sol-gel at 200 times magnification.

FIG. 5B is an SEM micrograph of a 30 vol. % B₄C/Al₂O₃ sol-gel at 500 times magnification

FIG. 6A is an SEM micrograph of a pellet of Sample J at 30,000 times magnification.

FIG. 6B is an SEM micrograph of a pellet of Sample J at 15,000 times magnification.

### DETAILED DESCRIPTION OF THE INVENTION

Uniform blends of one powder into another powder of different particle sizes and densities are difficult to achieve by current commercial methods. Such uniform blends are needed before powders can be consolidated into components having uniform microstructures that achieve higher strengths and more uniform properties. Microstructure refers to the structure as seen under a microscope. Disclosed herein is a method for the preparation of materials having ultrafine cell/pore sizes, continuous porosity, high surface area, and a microstructure composed of interconnected colloidal-like particles or polymeric chains with characteristic diameters in the 100 Å range. It is this microstructure that dictates the materials' optical, acoustical, thermal and mechanical properties.

The sol-gel process disclosed herein produces materials (1) having intimate homogeneous dispersions of materials offering the ability to control the size of one component within the other and (2) affording a material that will densify (sinter) at reduced temperatures. The dispersions can be prepared by either mechanical distribution of particles in relation to each other or by chemical dispersion.

Metal oxide sol particles in an aqueous solution acquire a surface charge depending on the pH of that solution and the chemical characteristics of the specific metal oxide or hydroxide. When a solution contains a high volume fraction of these particles the interactions between those particles affect the solution rheology and microstructure of a resulting dry powder compacts. The isoelectric point of any insoluble metal oxide (e.g., alumina) is the solution pH at which individual metal oxide particles have no net charge on them. The isoelectic point for an aluminum oxide sol is 9.1. In this application the metal oxide sample cited, aluminum oxide gel, is treated after its formation to give a solution pH of 9 to achieve the isoelectric point for this particular material. This specific treatment of the solution to the isoelectic point of the oxide matrix in question is critical to the desirable free-flowing powder morphology obtained from materials derived by this route. Blends of powders were prepared in order to uniformly disperse commercial powders, e.g., carbides, nitrides, borides, and metals, into a very fine powder matrix, e.g., Al₂O₃. The blends were then cold pressed to consolidate the powders into disks and the dispersion of the disks was evaluated. Two methods to fabricate composite materials wherein the individual component materials have particle sizes different from each other are disclosed herein.

One method of fabricating composite materials with individual component materials having different particle sizes comprises dissolving a metal salt in a solvent matrix to form a metal salt solution; adding a proton scavenger to the metal salt solution to form a gel; optionally adding a base to the gel; washing the gel with a predetermined solvent; and drying the gel to form a composite material.

The gel can comprise any metal oxide. Al₂O₃, MgO, CaO, ZrO₂, and Y₂O₃ are effective. The solvent matrix can comprise any solvent or combination of solvents that the metal salt is soluble in. A proton scavenger is any molecule that is capable of binding to a hydrogen ion (H⁺). Ammonia (NH₃) and epoxides, e.g., propylene oxide, are effective proton scavengers. The gel is washed with a solvent. In some cases, the gel is washed to remove salts produced by the proton scavenger addition and in other cases, the gel is washed to complete the gel-forming reaction. A composite material can be formed from the gel by air-drying, freeze drying, vacuum drying, or drying under an inert atmosphere, e.g., argon or nitrogen flow. A slow uniform pH rise leads to small uniform particle sizes. Small particle sizes decrease the chance for crack propagation in the gel. Once formed, the density of the composite material can be increased by sintering.

Another method of fabricating composite materials with individual component materials having different particle sizes comprise dissolving a metal salt in a solvent matrix to form a metal salt solution; adding a uniformly dispersed powdered materials to said metal salt solution to form a composite dispersion; adding a proton scavenger to the composite dispersion to form a gel; adding a base to the gel; optionally washing the gel with a predetermined solvent; and drying the gel to form a composite material.

The gel can comprise any metal oxide. Al₂O₃, MgO, CaO, ZrO₂, and Y₂O₃ are effective. The solvent matrix can comprise any solvent or combination of solvents that the metal salt is soluble in. The powdered material serves as a grain-size growth inhibitor and can either be commercial or custom synthesized. Effective grain-size growth inhibitors include TiC and B₄C. A proton scavenger is any molecule that is capable of binding to a hydrogen ion (H⁺). Ammonia (NH₃) and epoxides, e.g., propylene oxide, are effective proton scavengers. The gel is washed with a solvent. In some cases, the gel is washed to remove salts produced by the proton scavenger addition and in other cases, the gel is washed to complete the gel-forming reaction. A composite material can be formed from the gel by air-drying, vacuum drying, or drying under an inert atmosphere, e.g., argon or nitrogen flow. Once formed, the density of the composite material can be increased by sintering.

The following example is a sol-gel synthesis that results in the formation of a composite material. Seventy grams of AlCl₃.6H₂O (metal salt) was dissolved in a solution of 28 grams water and 280 grams ethanol (solvent matrix) in a 1 liter round bottom flask equipped with stirring. When dissolved, 70 grams of propylene oxide (proton scavenger) was added while stirring vigorously to form a gel. Vigorous stirring prevents the resulting gel from forming a monolith. Thirty-six grams (1 equivalent) of 28-30% NH₄OH (base) in 50 ml of EtOH was then added. Rotary evaporation with 3×500 ml aliquots of EtOH (washing) was used to remove volatile reactants. The resulting gel was taken to near dryness on the rotary evaporator and then vacuum dried at 100° C. overnight to yield 34.5 grams of product. The resultant gel has average particle dimensions ranging form 5-15 nm.

The preparation of 11 gels (Samples A through K) are described below and summarized in Table 1.

TABLE 1

| SAMPLE | COMPOSITION | PREPARATION |
|---|---|---|
| Sample A | Al₂O₃ | crystalline aerogel made from Aluminum |
| | | sec-butoxide by acetic acid method |
| Sample B | Al₂O₃ | Xerogel |
| Sample C | Al₂O₃ | air dried powder |
| Sample D | Al₂O₃/B₄C | air dried powder |
| Sample E | Al₂O₃ | NH₄OH washed powder |
| Sample F | Al₂O₃/B₄C | NH₄OH washed powder |
| Sample G | Al₂O₃ | Acetone washed powder |
| Sample H | Al₂O₃ | Acetone washed powder |
| Sample I | Al₂O₃ | Acetone washed powder |
| Sample J | Al₂O₃ | NH₄OH |
| | | washed and acetone washed powder |
| Sample K | Al₂O₃/TiC | EtOH washed granular solid |

Sample A is a crystalline aerogel prepared from Aluminum sec-butoxide by the acetic acid method. See “Synthesis of High Porosity, Monolithic Alumina Aerogels” J. F. Poco, J. H. Satcher Jr., and L. W. Hrubesh; J. Non-Cryst Solids, 285 (1-3), 57-63 (2001).

Sample B was prepared as follows: 10 g of AlCl₆.6H₂O was added to a 150 ml beaker equipped with a Teflon® stir bar and dissolved in 10 g EtOH and 1 g H₂O. While stirring 0.456 g (23% by volume B₄C/[Al₂O₃+B₄C]) of B₄C powder (density 2.52 g/cc; particle size 0.1-2 μm diameter) was added, followed by the addition of 9.6 g of propylene oxide. The gel set up in about 10 minutes and was dried overnight. It was then washed with 1% NH₄OH and air dried overnight to yield 3.9 69 g of Al₂O₃/B₄C xerogel.

Sample C was prepared as follows: 100 g of AlCl₆.6H₂O was added to a 1 L beaker equipped with a Teflon® sir bar and dissolved in 400 g of EtOH. While stirring, 100 g of propylene oxide was added. After about 5 minutes the stir bar was removed. The gel set about 10 minutes after the propylene oxide addition. The gel was broken up with a spatula and washed with NH₄OH (pH about 9) with stirring overnight. It was then filtered, washed with the NH₄OH solution and allowed to air dry overnight. A gelatinous mass was formed. The gelatinous mass was ground to a near dry powder and weighed 36.09 g.

Sample D was prepared as follows: 70 g of AlCl₆.66H₂O was added to a 1 L beaker equipped with a Teflon® stir bar. 28 g of H₂O was added followed by 280 g EtOH and the mixture was stirred. After the AlCl₆.6H₂O was completely dissolved, 4.561 g (30% by volume B₄C [Al₂O₃+B₄C]) of B₄C (density 2.52 g/cc; particle size 0.1-2 μm diameter) was added. When the B₄C was uniformly dispersed, 70 g of propylene oxide was added while stirring and the stirring was continued until the gel set. The gel was broken up, filtered and washed with a 50/50 solution of EtOH/0.3% NH₄OH and air dried to yield an Al/B₄C xerogel weighing 29.29 g.

Sample E was prepared as follows: 300 g of AlCl₆.6H₂O was added to a large flask equipped with a Teflon® sir bar and dissolved in 1200 g of EtOH. While stirring, 300 g of propylene oxide was added and a gel formed. About ⅔ of the mother liquor was decanted and the gel was broken up with stirring overnight. The pieces of gel were filtered, washed with the 1% NH₄OH (aq) solution and allowed to air dry overnight to form hard clumps. The hard clumps were ground by mixing with H₂O in a blender. The blended mixture was poured into a tray and air dried over 7 days. The dry material was then filtered, washed 3 times with acetone, and allowed to air dry. The reaction yielded about 90 g of Al₂O₃ xerogel.

Sample F was prepared as follows: 300 g of AlCl₆.6H₂O was added to a large flask equipped with a Teflon® stir bar. 120 g of H₂O was added followed by 1200 g EtOH. After the AlCl₆.6H₂O was completely dissolved, 19.547 g (30% by volume B₄C/[Al₂O₃+B₄C]) of B₄C (density 2.52 g/cc; particle size 0.1-2 μm diameter) was added to the AlCl₆.6H₂O solution. When the B₄C was uniformly dispersed, 300 g propylene oxide was added while stirring and the stirring was continued until the gel set. The next day, ⅔ of the mother liquor was decanted and the gel was broken up with stirring overnight. Next the gel pieces were filtered, washed with a 1% solution of NH₄OH (aq) and air dried for 3 days. The gel pieces were then blended in a blender with 1% NH₄OH (aq), poured into a tray, air dried for 3 days, washed with acetone 3 times, air dried for 3 more days and rinsed with acetone again.

Sample G was prepared as follows: 80 g of AlCl₆.6H₂O was added to a 1 L beaker equipped with a Teflon® sir bar and dissolved in 32 g of H2O and 192 g of EtOH. While stirring, 49.6 g of propylene oxide was added. After about 5 minutes the stir bar was removed. The gel set within about 10 minutes of the propylene oxide addition. The gel was broken up, put into a petri dish and washed with acetone.

Sample H was prepared as follows: 80 g of AlCl₆.6H₂O was added to a 1 L beaker equipped with a Teflon® sir bar and dissolved in 32 g H2O and 192 g of EtOH (about 1 hour to completely dissolve). While stirring, 49.6 g of propylene oxide was added. The gel set within about 15 minutes of the propylene oxide addition and after about 25 minutes the stir bar stopped. 500 ml of acetone was added to break up the gel with stirring overnight. The gel was then filtered, washed several times with acetone and allowed to air dry overnight.

Sample I was prepared as follows: 80 g of AlCl₆.6H₂O was added to a 1 L beaker equipped with a Teflon® sir bar and dissolved in 32 g H2O and 192 g of EtOH (about 1 hour to completely dissolve). While stirring, 77 g of propylene oxide was added. The gel set within about 15 minutes of the propylene oxide addition and after about 25 minutes the stir bar stopped. 500 ml of acetone was added to break up the gel with stirring overnight. The gel was then filtered, washed several times with acetone and allowed to air dry overnight. The reaction yielded 38.91 g of product.

Sample J was prepared as follows: 2400 g of AlCl₆.6H₂O was added to a 5 gallon bucket equipped with a Teflon® sir bar and lid and dissolved in 960 g of H₂O and 9600 g of EtOH. While stirring, 2310 g of propylene oxide was added and the temperature increased to about 35° C. The gel set within about 5 minutes of the propylene oxide addition. The solvent was drained from the gel and the gel was washed with NH₄OH (pH about 9) several times until the pH was unchanged. The gel was soaked overnight in NH₄OH (pH about 9). The ammonium hydroxide was drained and gel mixed with acetone and soaked in acetone overnight. The acetone was drained and the gel was poured into a flat tray and allowed to air dry.

Sample K was prepared as follows: 70 g AlCl₆.6H₂O was added to a 1 L round bottom flask equipped with a Teflon® stir bar and dissolved in 28 g H₂O and 250 g EtOH. When completely dissolved 10.25 g TiC powder (density −4.95 g/cc, particle size 0.25-10 μm diameter) was added (33 vol. % TiC/Al₂O₃. When thoroughly mixed, 70 g propylene oxide was added while stirring. Gel formed, but gel was kept broken-up to maximize the dissipation of TiC. After 2 hours, 36 g of NH₄OH(aq) in 50 ml of EtOH was added. The mixture was stirred for about 2 hours and the solvent removed on a rotary evaporator at 80° C. 500 ml of EtOH was added and the mixture was stirred until the gel broke up. The mixture was then rotary evaporated to near dryness. Another 500 ml aliquot of EtOH was added and the mixture was stirred overnight. Rotary evaporation led to the recovery of a charcoal gray granular solid which was placed in a vacuum oven at 100° C. for several days to yield 44.75 g of Al₂O₃/TiC (33% V/V) xerogel.

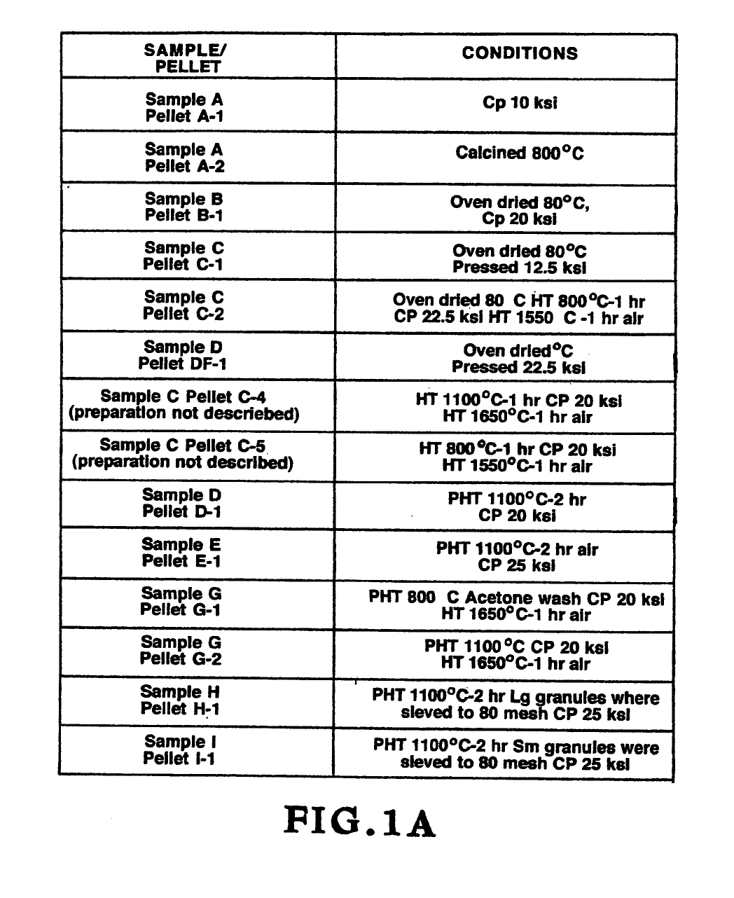

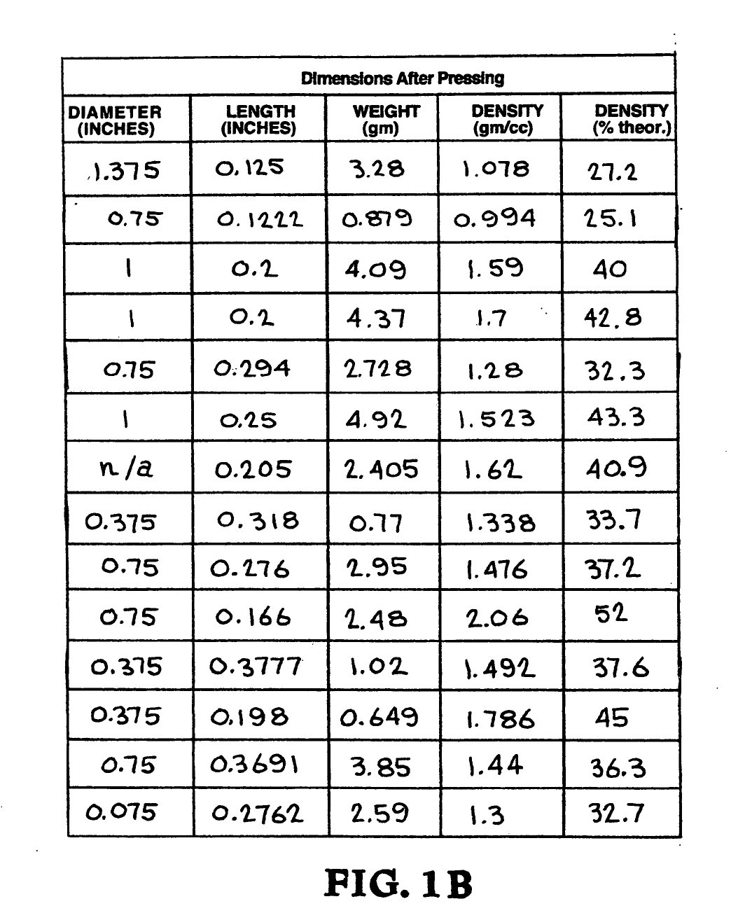

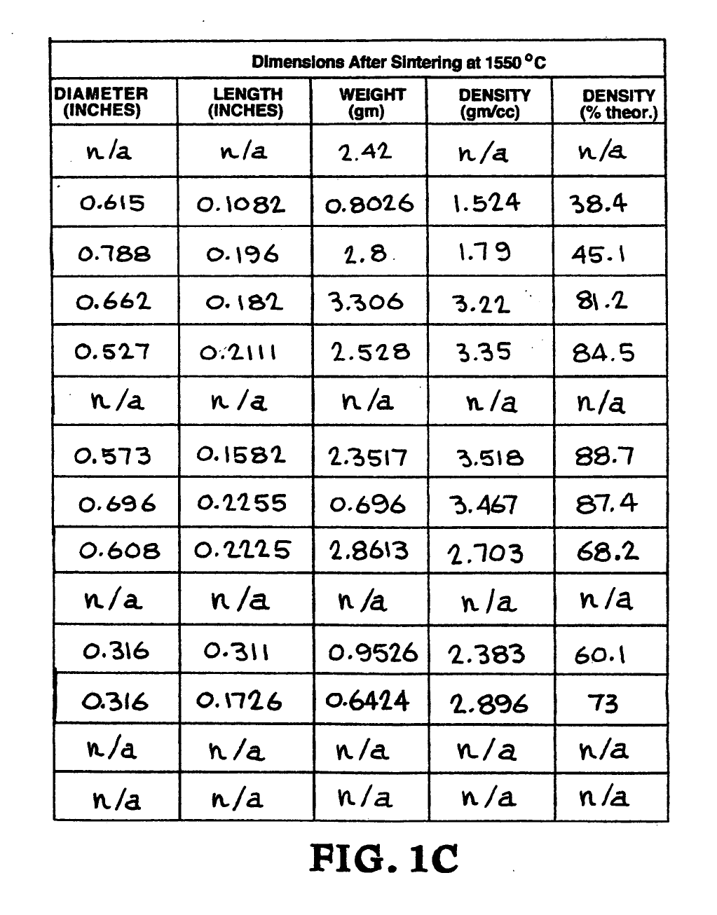

Results of the pellets formed by pressing Samples A-K are listed in FIG. 1 and/or described below.

Sample A was first evaluated without pressing. Sample A lost 1.81% of its weight when oven dried at 80° C. overnight. It lost another 22.25% of its weight after sintering at 1000° C. for 1 hour in air. When sintered in air to 1550° C., it lost another 5.95% of its weight and decreased in size from approximately a 1 inch cube to less than a ¼ inch cube. It sintered to a density of 63.2% (theoretical density is 3.965 grams/cm³). The sintered piece was hard but low strength. Higher sintering temperatures would be needed to achieve higher densities and/or greater strengths. Cold pressing and sintering of Sample A was also attempted to achieve higher densities.

Referring to FIG. 1, direct pressing of the aerogel in a steel die at 10,000 psi resulted in a pellet (pellet A-1) that delaminated during sintering. This delaminating was caused by the large amount of gases released from the pellet during sintering. Pellet A-2 was first heat treated to 800° C. for one hour in air and then cold pressed into a pellet While the pre-heat treatment helped maintain the shape of the pellet during the sintering process (1550° C. for one hour in air), it had a very low density (38.4% of theoretical density) and strength. Higher pre-heat treating temperatures will be needed to reduce the weight loss (8.69%) of Sample A if higher densities are desired.

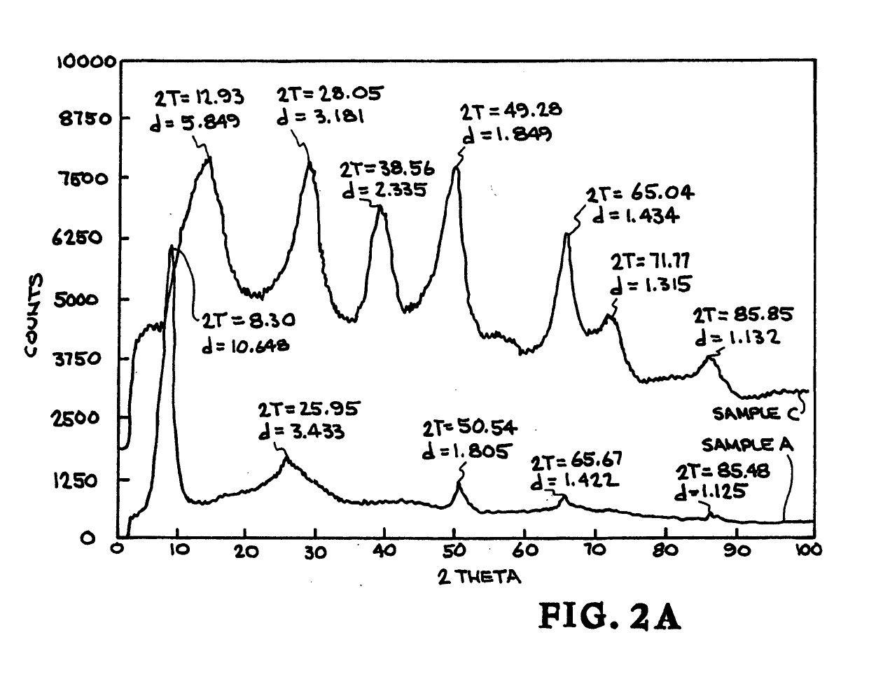

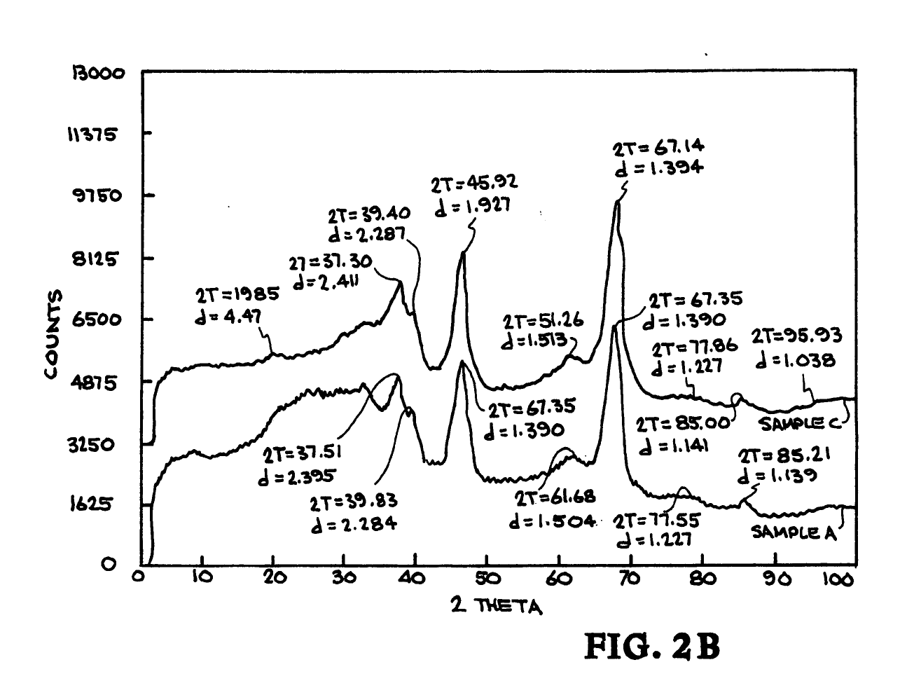

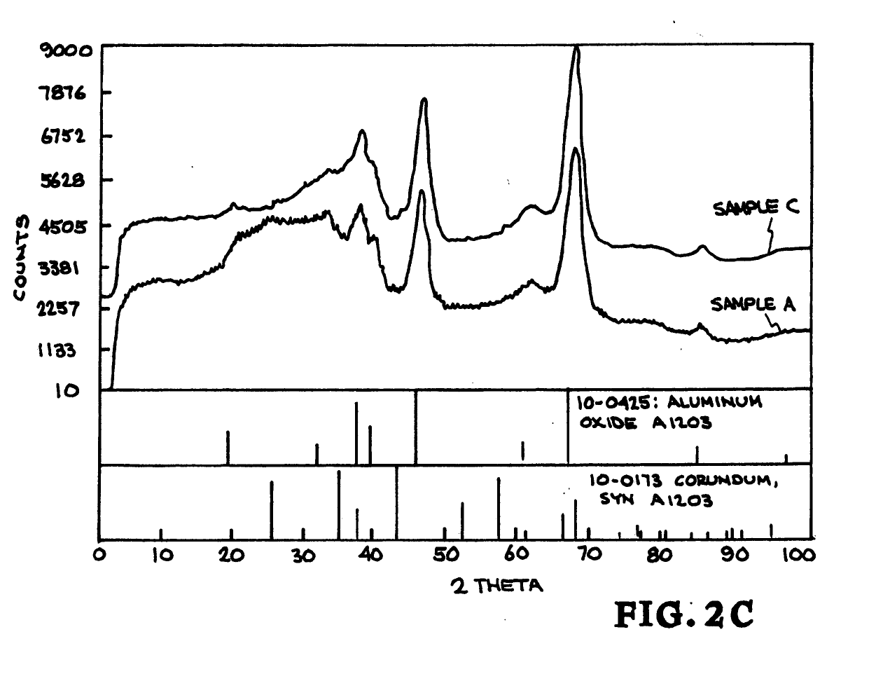

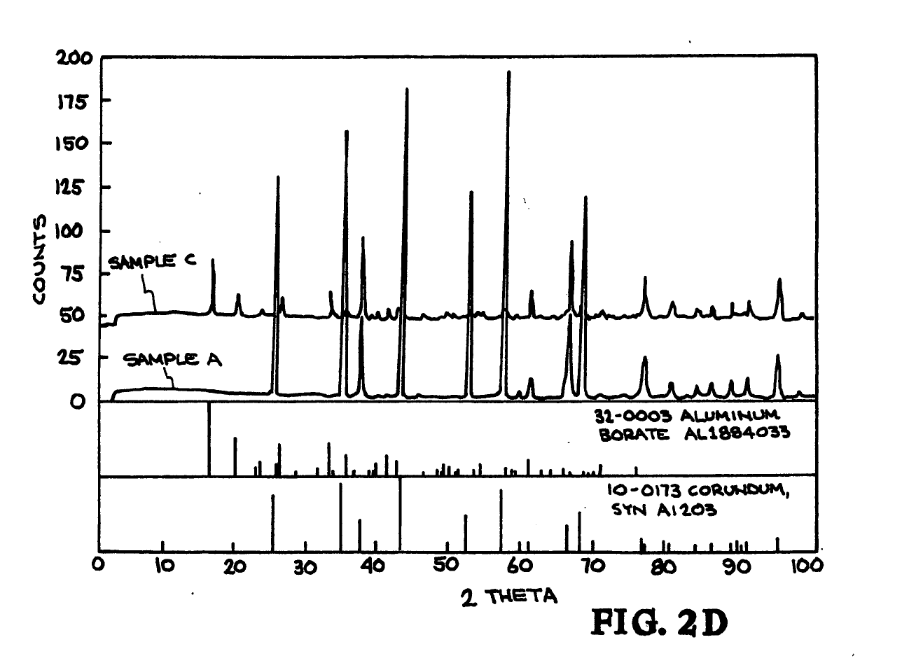

X-ray diffraction patterns of Sample A and Sample C are shown in FIGS. 2A-2D. The oven-dried stage in FIG. 2A shows a broad amorphous and fine crystalline pattern that does not match any lines for Al₂O₃ or corundum ceramics. After heat treating pellet A-2 to 800° C. (pre-sintering), a few peaks of the desired ceramics appear but are still very broad and many of the unknown amorphous peaks still exist (see FIG. 2B and FIG. 2C). After the 1550° C. sintering process (see FIG. 2D), the x-ray pattern of pellet A-2 is much sharper and shows all of the ceramic peaks desired with a very fine grain size (calculated at 800 Å). Pellet A-2 contained a background contamination identified as aluminum boride. This contamination was attributed to some cross contamination of B₄C powder used in another sample.

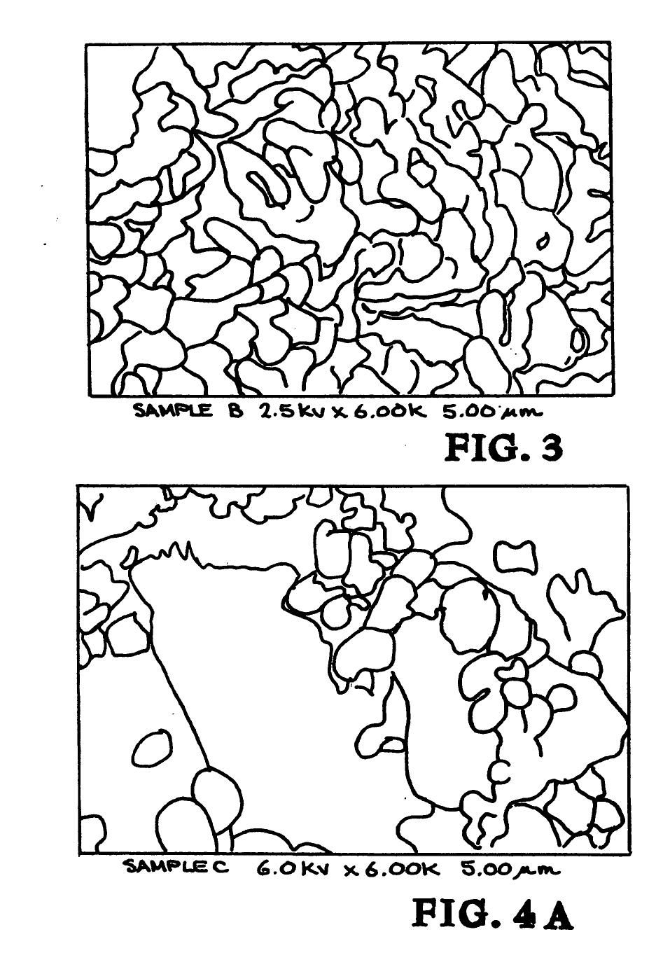

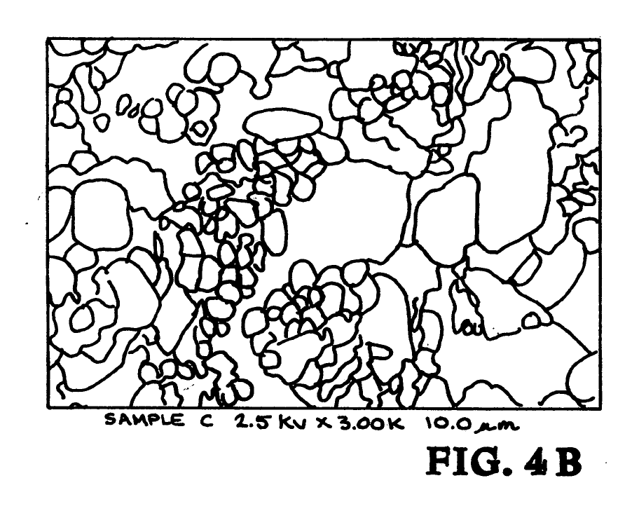

Aerogel Sample B and aerogel Sample C were prepared as air-dried granules. One pellet was cold pressed and sintered from Sample B, pellet B-1. Pellet B-1 was cold pressed from the oven dried granules and sintered at 1550° C. A large weight loss (36.7%) was the main factor creating the low sintered density (45.1% of theoretical density). Two pellets were cold pressed and sintered from Sample C, pellet C-1 and pellet C-2. The granules for pellets C-1 and C-2 were ball milled in an Al₂O₃ mill/ball system over night. Subsequent sieving reduced these granules to a size less than 80 mesh (<177 microns). Pellet C-1 was cold pressed and sintered to a density of 81.2% even with a weight loss of 38.6%. For further increase in density, pellet C-2 was heat treated to 800° C. for 1 hour before cold pressing and sintering. Pellet C-2 lost 29.1% by weight from the 800° C. heat treatment and another 3.35% during sintering at 1550° C. Pre-heat treating the powder reduces the gases coming off during sintering and thus increases the density. Results for pellets B-1, C-1 and C-2 are summarized in FIG. 1. FIG. 3 is an SEM micrograph of Sample B. FIGS. 4A and 4B are SEM micrographs of Sample C at different levels of magnification, 6,000 times and 3,000 times, respectively.

The x-ray diffraction patterns of Sample C and the pellets formed from Sample C, i.e., pellet C-1 and pellet C-2, are also shown in FIGS. 2A-2D. The pattern of the as-received granules in FIG. 2A are significantly different from Sample A and do not correspond to any Al₂O₃ ceramic patterns expected. After pre-heat treating Sample C to 800° C., the granules form a pattern (shown in FIG. 2B) that is very similar to pre-heat treated Sample A. The two ceramic patterns are listed below the aerogel patterns in FIG. 2C. The patterns become very sharp and crystalline after the 1550° C. sintering step as shown in FIG. 2D.

The granules from Sample E and Sample G were also pre-heat treated at 800° C. for one hour. These granules lost 40.3% and 28.6% by weight, respectively (see FIG. 1).

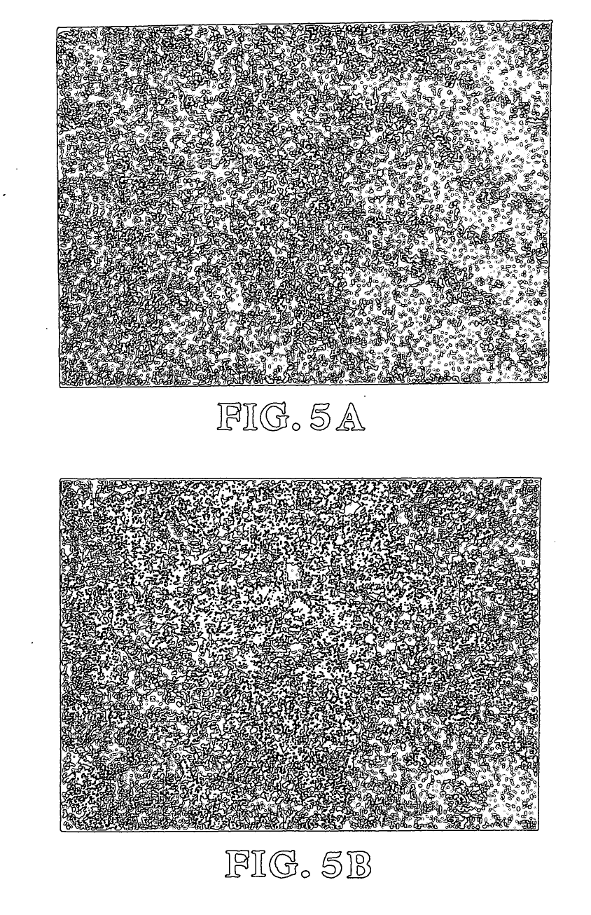

Sample D and Sample F were ball-milled to form granule mixtures of 30% by volume B₄C fine powder (<2 μm) and Al₂O₃ aerogel. After oven drying these ball-milled granules to −80 mesh, a pellet was cold pressed and sintered to 1550° C. The B₄C was converted into B₂O₃ and reacted with the Al₂O₃ to form an aluminum boride pellet, i.e., pellet DF-1 in referred to in FIG. 1. Sintering this powder under vacuum or providing a reducing environment while sintering will prevent the B₄O to B₂O₃ reaction. FIGS. 5A and 5B are an SEM micrographs of a 30 vol. % B₄C/Al₂O₃ sol-gel.

Two batches of sol-gel powder, Sample D and Sample E, were prepared for consolidation into pellets by hot pressing. The application of pressure during the sintering of these powders at lower temperatures (1500° C.) should result in less grain growth and higher densities. Sample E was washed with NH₄OH and Sample D was only air-dried. Both Sample D and Sample E were oven dried at 80° C. for 24 hours and ball milled for 24 hours before sieving through an 80 mesh sieve. Roughly 30 weight percent of organic compounds were still present in each resulting powder, but these organic compounds vaporized before the powders reach 1100° C. in the hot pressing operation. The powders were loaded into graphfoil lined graphite dies and punches and a pressure of 1,000 psi was applied through the punches onto the powders before heating the die assembly to 1100° C. At this temperature, all the organic compounds were vaporized and escape along the gaps between the dies and punches. The B₄C powder in Sample D was protected from oxidizing by a nitrogen atmosphere and the reducing environment produced by the graphite dies. After reaching 1100° C., the pressure was increased to 3,000 psi and the temperature increased to 1500° C. The powders were densified at 3,000 psi and 1500° C. for 15 minutes before releasing the pressure and lowering the temperature to ambient conditions.

The densities of the resulting hot pressed pellets, D-1 and E-1, were determined by the immersion density method in water. The pellets measure 1 inch diameter by ⅛ inch thickness. The E-1 pellet was near full density and the D-1 pellet had slight interconnecting porosity of a few percent. The cross sectional section of each pellet was mounted and polished for microstructure examination.

FIG. 5A shows the polished face of pellet D-1 at 200 times magnification. A very fine and uniform dispersion of B₄C particles in an Al₂O₃ matrix can be seen. FIG. 5B shows the polished face of pellet D-1 at 500 times magnification. Even at 500 times magnification, the resolution of particles is still hard to detect, thus indicating a sub-micron structure. No porosity could be resolved from the amplification available, so it is possible that the pores detected by immersion density could be surface pores at the edge of the pellet.

Isolated regions of pores result from entrapped pores in the larger agglomerates not broken down during the ball milling and sieving operations. Future processing is required to reduce the powder to less than 325 mesh. The sub-micron microstructure of pellet D-1 is beyond the limits of the light microscope, but could be studied with SEM and TEM methods.

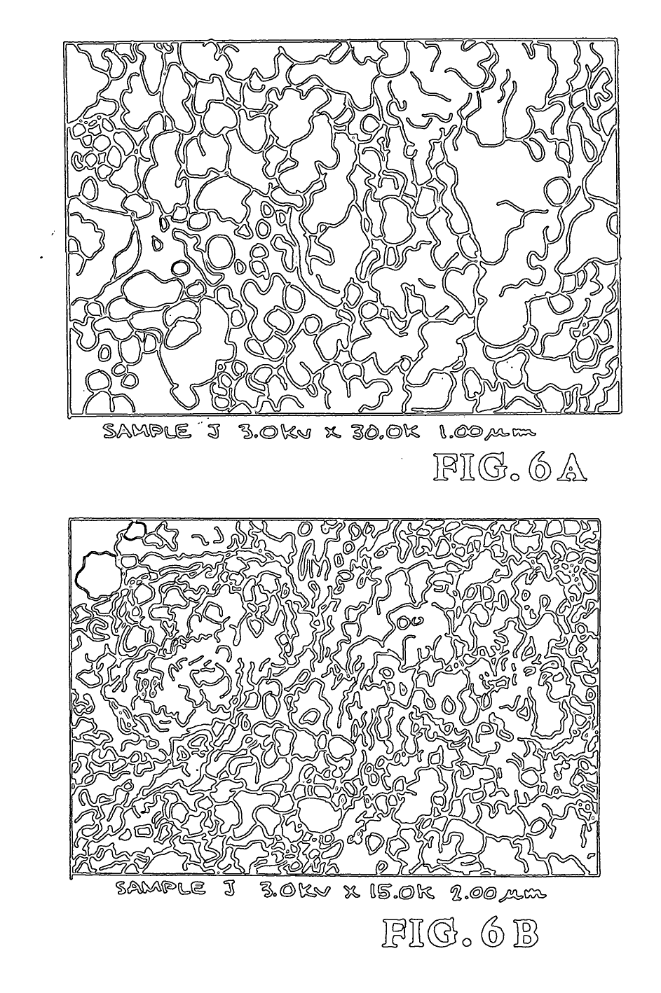

SEM micrographs of Sample J (Al₂O₃ ammonia washed powder) are shown in FIGS. 6A and 6B.

Sample K, 33 vol. % TiC/Al₂O₃ produced from commercial TiC powder (density −4.93 g/cc, particle size 0.25-10 μm diameter) and sol gel Al₂O₃ powder, was hot pressed to full density. The hot pressed disk was cut into four-point bend test bars and two cutting tools. The four-point bent test is described at the web address npl.co.uk/vamas/fourpoint-help.html. The fracture toughness was measured at 4.3 Mpa/m (megapascals per meter) and the fracture strength was 44Ksi.

Results of initial densification attempts via hot isostatic pressing (HIP) of some powders is summarized in Table 3.

TABLE 3

| | | | | | |
|---|---|---|---|---|---|
| | | | | Sound | Shear |
| Sample | | | Density | Velocity | Velocity |
| ID | Composition | Conditions | (gm/cc)/% | mm/μsec | mm/μu |

Hot Pressed Nano-Powders from Sol-gel Process

| | | | | | |
|---|---|---|---|---|---|
| Sample | Al₂O₃ | Hot Pressed | 3.73/94 | 10.213 | 6.4 |
| J (J-1) | | 1600° C. | | | |
| Sample | Al₂O₃ | Hot Pressed | 3.93/100 | 11.018 | 6.7 |
| J (J-2) | | 1750° C. | | | |
| Sample | Al₂O₃ | Hot Pressed | 3.35/85 | n/a | n/a |
| J (J-2) | | 1600° C. | | | |
| Sample | Al₂O₃ | Hot Pressed | 3.76/95 | n/a | n/a |
| J (J-2) | | 1750° C. | | | |
| Sample | 30 vol. % | Hot Pressed | 3.5/87 | n/a | n/a |
| D | B₄C/Al₂O₃ | 1600° C. | | | |
| Sample | 33 vol. % | Hot Pressed | 3.6/84 | n/a | n/a |
| K | TiC/Al₂O₃ | 1600° C. | | | |

Hot Pressed Nano-Powders from commercial Process

| | | | | | |
|---|---|---|---|---|---|
| GEM-2 | 33 vol. % | Hot Pressed | 4.24/100 | 10.439 | 6.1 |
| | TiC/Al₂O₃ | 1750° C. | | | |
| Cermet- | 45 vol. % | Infilt. | 2.62/100 | 11.219 | 6.8 |
| 1 | B₄C/Al | 1100° C. | | | |

Fully dense pellets can be obtained, if desired, by slightly modifying the powder preparation and hot pressing procedures. For instance, optimal packing efficiency can be obtained by optimizing the distribution of varying particle sizes. Reduction of the large agglomerates in the powder will eliminate the regions of pores seen in FIG. 1. Alternately, if a uniformly porous body is desired for the application in mind (filters, solid-oxide fuel cells, membranes, etc.), these agglomerates may be desirable. In applications where strength and non-permeability are desired (ceramic cutting tools, wear parts, auto parts, etc.), these porous regions can be eliminated by proper ceramic processing procedures or during the aerogel processing. Any other oxide can be added during aerogel processing to obtain different properties. Some examples include MgO, CaO, ZrO₂, and Y₂O₃. NH₄OH washed powder lost the most weight while acetone washed powder lost the least.

All numbers expressing quantities of ingredients, constituents, reaction conditions, and so forth used in the specification and claims are to be understood as being modified in all instances by the term “about”. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

1. A method comprising:
dissolving at least one metal salt in a solvent or solvent matrix to form a metal salt solution;
adding a proton scavenger to said metal salt solution to form a gel;
washing said gel with a solvent having a ph that will produce about no net charge in at least a portion of said gel; and
drying said gel to form a composite material.

2. The method of claim 1, further comprising adding a base to said gel.

3. The method of claim 1, wherein said at least one metal salt comprises a plurality of metal salts comprising at least two particle sizes.

4. The method of claim 1, wherein said gel comprises particle dimensions ranging about from to 1 nm to 1,000 nm.

5. The method of claim 1, further comprising sintering said composite material.

6. The method of claim 1, further comprising adding at least one uniformly dispersed powdered material to said metal salt solution to form a composite dispersion, wherein said powdered material is selected from the group consisting of a carbide, a nitride, a boride and a metal.

7. The method of claim 6, wherein said carbide is selected from the group consisting of B4C, SiC, TiC, VC, CrC, ZrC, HfC, TaC, WC, NbC, YC, SmC and UC, wherein said nitride is selected from the group consisting of BN, AlN, Si3N4, TiN, VN, CrN, YN, ZrN, NbN, MoN, HfN, TaN, SmN and UN, wherein said boride is selected from the group consisting of BexBy, AlBx, SiBx, TiB2, VBx, YB, ZrB, NbB, MAB, HfB, TaB, WBx, SmB and UBx and wherein said metal is selected from the group consisting of BE, B, Al, Si, Ti, V, Cr, Fe, Co, Ni, Cu, Y, Zr, Nb, Mo, Ag, Hf, Ta, W, Re, Pt, Ce, Sm, Th and U.

8. A method comprising:
dissolving at least one metal salt in a solvent or solvent matrix to form a metal salt solution;
adding at least one uniformly dispersed powdered material to said metal salt solution to form a composite dispersion;
adding a proton scavenger to said composite dispersion to form a gel;
washing said gel with a solvent having a ph that will produce about no net charge in at least a portion of said gel; and
drying said gel to form a composite material.

9. The method of claim 8, further comprising adding a base to the gel.

10. The method of claim 8, wherein said at least one uniformly dispersed powdered material has a particle size different from the particle size of said at least one metal salt.

11. The method of claim 8, wherein said gel comprises at least two particle sizes.

12. The method of claim 8, wherein said gel comprises particle dimensions ranging from about 1 nm to 1,000 nm and wherein said at least one uniformly dispersed powdered material comprises particle dimensions ranging from about 0.1 μm to 100 μm.

13. The method of claim 8, further comprising sintering said composite material.

14. The method of claim 8, wherein said at least one uniformly dispersed powdered material is selected from the group consisting of a carbide, a nitride, a boride and a metal.

15. The method of claim 14, wherein said carbide is selected from the group consisting of B4C, SiC, TiC, VC, CrC, ZrC, HfC, TaC, WC, NbC, YC, SmC and UC, wherein said nitride is selected from the group consisting of BN, AlN, Si3N4, TIN, VN, CrN, YN, ZrN, NbN, MoN, HfN, TaN, SmN and UN, wherein said boride is selected from the group consisting of BexBy, AlBx, SiBx, TiB2, VBx, YB, ZrB, NbB, MoB, HfB, TaB, WBx, SmB and UBx and wherein said metal is selected from the group consisting of BE, B, Al, Si, Ti, V, Cr, Fe, Co, Ni, Cu, Y, Zr, Nb, Mo, Ag, Hf, Ta, W, Re, Pt, Ce, Sm, Th and U.

16. The method of claim 8, further comprising sintering said gel to form a nano-ceramic material.

17. A method comprising:
dissolving at least one metal salt in a solvent or solvent matrix to form a metal salt solution;
adding at least one uniformly dispersed powdered material to said metal salt solution to form a composite dispersion, wherein said powdered material is selected from the group consisting of a carbide, a nitride, a boride and a metal;
adding a proton scavenger to said composite dispersion to form a gel;
washing said gel with a solvent having a ph that will produce about no net charge in at least a portion of said gel; and
drying said gel to form a composite material.

18. (canceled)

19. The method of claim 17, wherein said carbide is selected from the group consisting of B₄C, SiC, TiC, VC, CrC, ZrC, HfC, TaC, WC, NbC, YC, SmC and UC, wherein said nitride is selected from the group consisting of BN, AlN, Si3N4, TiN, VN, CrN, YN, ZrN, NbN, MoN, HfN, TaN, SmN and UN, wherein said boride is selected from the group consisting of BexBy, AlBx, SiBx, TiB2, VBx, YB, ZrB, NhB, MoB, HfB, TaB, WBx, SmB and UBx and wherein said metal is selected from the group consisting of BE, B, Al, Si, Ti, V, Cr, Fe, Co, Ni, Cu, Y, Zr, Nb, Mo, Ag, Hf, Ta, W, Re, Pt, Ce, Sm, Th and U.
